(19) United States
(12) Patent Application Publication
(10) Pub. No.: US 2012/0097325 A1
(43) Pub. Date: Apr. 26, 2012

(54) SYSTEM AND METHOD FOR CONTINUOUSLY MANUFACTURING LIQUID CRYSTAL DISPLAY DEVICE

(75) Inventors: Kazuya Hada, Osaka (JP); Seiji Umemoto, Osaka (JP)

(73) Assignee: NITTO DENKO CORPORATION, Osaka (JP)

(21) Appl. No.: 13/278,402

(22) Filed: Oct. 21, 2011

(30) Foreign Application Priority Data
Oct. 21, 2010 (JP) 2010-236727

(51) Int. Cl. B32B 38/10

(52) U.S. Cl. 156/249

(57) ABSTRACT

A method for continuously manufacturing a liquid crystal display device, includes a first peeling step that comprises providing a carrier film on which first and second sheet pieces of polarizing films containing first and second pressure-sensitive adhesives, respectively, are formed, and peeling off the first sheet piece from the carrier film by first peeling means; a bonding step that comprises bonding the first sheet piece to a liquid crystal panel with the first pressure-sensitive adhesive interposed therebetween to form a liquid crystal display device; and a removal step that comprises removing the second sheet piece from the carrier film. The removal step includes a falling step comprising peeling off the second sheet piece from the carrier film using second peeling means by inwardly bending the carrier film against the second sheet piece with the second pressure-sensitive adhesive facing upward; and allowing the second sheet piece to fall.

### BACKGROUND OF THE INVENTION

1. Field of the Invention

The invention relates to a system and a method for continuously manufacturing a liquid crystal display device. More specifically, the invention relates to a system and a method for continuously manufacturing a liquid crystal display device, in which a defective sheet piece of a polarizing film or any other defective material can be peeled off from a carrier film and removed without being bonded to a liquid crystal panel.

2. Description of the Related Art

A known method for manufacturing a liquid crystal display device includes drawing, from a continuous roll, a carrier film on which a polarizing film and a pressure-sensitive adhesive are provided, cutting the polarizing film into a sheet piece, while leaving the carrier film (uncut), peeling off the sheet piece from the carrier film, and continuously bonding the sheet piece to a liquid crystal panel.

In this process, a sheet piece of a polarizing film containing defects such as scratches or foreign bodies (hereinafter referred to as “defective sheet piece”) should not be bonded to the liquid crystal panel. Concerning the above method for continuously manufacturing a liquid crystal display device, therefore, a defective sheet piece-removing method is known, which includes peeling off a defective sheet piece from a carrier film, bonding the defective sheet piece to another carrier film, and winding the another carrier film into a roll (Japanese Patent Application Laid-Open (JP-A) No. 57-052017, JP-A No. 2009-186994 and JP-A No. 2009-271521).

### PATENT DOCUMENT

1: Japanese Patent Application Laid-Open JP-A No. 57-052017.
2: Japanese Patent Application Laid-Open JP-A No. 2009-186994.
3: Japanese Patent Application Laid-Open JP-A No. 2009-271521.

Unfortunately, the techniques disclosed in Patent Documents 1 to 3 require an additional carrier film to which defective sheet pieces will be bonded, and in some cases, the manufacturing process is interrupted for the replacement of the additional carrier film, in which improvements have been demanded. It is therefore suggested that defective sheets themselves should be peeled off and removed without being bonded to such an additional carrier film. In such a case, however, when sheet pieces are formed adjacent to one another on a carrier film by half-cutting or the like, adhesive lacking (loss of part of the pressure-sensitive adhesive) or adhesive deposit (deposition caused by chipping of part of the pressure-sensitive adhesive) is more likely to occur due to re-adhesion between the pressure-sensitive adhesives.

### SUMMARY OF THE INVENTION

The invention has been made in view of the above circumstances, and an object of the invention is to provide a system and a method for manufacturing a liquid crystal display device, in which a sheet piece of a polarizing film not to be bonded to a liquid crystal panel can be removed while adhesive lacking or adhesive deposit is prevented.

As a result of earnest studies to solve the above problems, the invention described below has been accomplished.

The invention is directed to a system for continuously manufacturing a liquid crystal display device, including: first peeling means for peeling off, from a carrier film, a first sheet piece of a polarizing film containing a first pressure-sensitive adhesive, wherein the first sheet piece of the polarizing film is formed adjacent to a second sheet piece of a polarizing film containing a second pressure-sensitive adhesive with a score line interposed between the adjacent sheet pieces, the score line is perpendicular to the feed direction, and the first and second sheet pieces are formed on the carrier film with the first and second pressure-sensitive adhesives interposed therebetween, respectively; bonding means for bonding the first sheet piece, which is peeled off by the first peeling means, to a liquid crystal panel with the first pressure-sensitive adhesive interposed therebetween to form a liquid crystal display device; and removal means for removing the second sheet piece and the second pressure-sensitive adhesive from the carrier film, wherein the removal means includes second peeling means for peeling off the second sheet piece from the carrier film by inwardly bending the carrier film against the second sheet piece with the second pressure-sensitive adhesive facing upward, wherein the second sheet piece peeled off by the second peeling means is allowed to fall.

According to this feature, gravity acts on the second sheet piece, so that the second sheet piece is allowed to fall while or after the pressure-sensitive adhesives adhering again to each other (for example, the first and second pressure-sensitive adhesives) are once slowly dissociated from each other, and therefore, adhesive lacking or adhesive deposit caused by displacement of pressure-sensitive adhesives adhering to each other can be suppressed, so that the second sheet piece can be successfully removed without an additional carrier film as used in conventional techniques. FIG. 3 is a diagram for illustrating a mechanism for slowly dissociating the second sheet piece from the carrier film. As shown in FIG. 3, the pressure-sensitive adhesive surface of the upper layer is slowly dissociated by the effect of gravity acting on the second sheet piece.

In an embodiment of the invention, the second peeling means may peel off the second sheet piece from the carrier film by feeding the carrier film in an obliquely upward direction and then inwardly bending the carrier film against the second sheet piece with the second pressure-sensitive adhesive facing upward.

According to this feature, gravity acts on the second sheet piece, so that the second sheet piece is allowed to fall while or after the pressure-sensitive adhesives adhering again to each other are once slowly dissociated from each other in a preferred manner, and therefore, adhesive lacking or adhesive deposit caused by displacement of pressure-sensitive adhesives adhering to each other can be suppressed more effectively.

In an embodiment of the invention, the first peeling means for peeling off the first sheet piece from the carrier film may also serve as the second peeling means.

According to this feature, there is no need to provide the second peeling means separately, so that the system cost can be reduced.

In an embodiment of the invention, the bonding means preferably bonds the first sheet piece, which is peeled off by the first peeling means, to the liquid crystal panel from the lower side with the first pressure-sensitive adhesive interposed therebetween.

The removal means preferably further includes a bonding means shifting control unit for shifting the bonding means in such a manner that the falling of the second sheet piece peeled off from the carrier film by the second peeling means is not interfered with.

According to this feature, the bonding of the first sheet piece at the bonding position and the removal of the second sheet piece are both successfully achieved.

In an embodiment of the invention, the first sheet piece may be peeled off from the carrier film at a first peeling point, the second sheet piece may be peeled off from the carrier film at a second peeling point located upstream of the first peeling point, and the removal means may further include a peeling means shifting control unit for shifting the second peeling means to the second peeling point when the second sheet piece is peeled off from the carrier film.

According to this feature, the second peeling means for peeling off the second sheet piece is placed upstream of the bonding position of the bonding means, so that there is no risk of adhesion of the second sheet piece to the bonding means.

In an embodiment of the invention, the second peeling means may include part of a plurality of feed rollers for feeding the carrier film. The removal means may include a feed roller shifting unit for shifting the feed roller. According to this feature, the second sheet piece can be peeled off using a simple device configuration.

In an embodiment of the invention, the system preferably further includes a dancer roller placed upstream of the second peeling means. In this case, the carrier film can be fed backward to the upstream side in the process of returning the second peeling means to an original position after the second sheet piece is peeled off, so that in the returning process, the first sheet piece located upstream of the second sheet piece can be prevented from causing defects (such as deformation and foreign matter contamination), which would otherwise be caused by the exposure of the first pressure-sensitive adhesive when the second peeling means is operated.

In an embodiment of the invention, the removal means may further include holding means for holding the fallen second sheet piece.

According to this feature, the fallen second sheet pieces can be collected while the second pressure-sensitive adhesive is prevented from adhering to the surrounding devices. In addition, when the second sheet pieces are piled in the holding means, new holding means can be substituted by easy operation without stopping the manufacturing line.

The holding means preferably has a release-treated holding surface for coming into contact with the fallen second sheet piece. Examples of the release treatment include an embossing treatment for forming a surface with irregularities, a chemical coating treatment with silicone or any other release agent, and a release film-bonding process. When the holding surface is subjected to the release treatment, the second pressure-sensitive adhesive of the second sheet piece is successfully prevented from adhering to the holding surface.

The holding means preferably further includes an underlay member removably provided on at least the holding bottom surface. The second sheet pieces can be easily removed by removing the underlay member.

The invention is directed to a method for continuously manufacturing a liquid crystal display device, including:

a first peeling step includes providing a carrier film on which first and second sheet pieces of polarizing films containing first and second pressure-sensitive adhesives, respectively, are formed, and peeling off the first sheet piece from the carrier film by first peeling means, wherein the first and second sheet pieces are adjacent to each other with a score line interposed therebetween and formed on the carrier film with the first and second pressure-sensitive adhesives interposed therebetween, respectively, and the score line is perpendicular to a feed direction;

a bonding step includes bonding the first sheet piece, which is peeled off in the first peeling step, to a liquid crystal panel with the first pressure-sensitive adhesive interposed therebetween to form a liquid crystal display device; and

a removal step includes removing the second sheet piece from the carrier film, wherein

the removal step comprises a falling step includes peeling off the second sheet piece from the carrier film using second peeling means by inwardly bending the carrier film against the second sheet piece with the second pressure-sensitive adhesive facing upward; and allowing the second sheet piece to fall.

According to this feature, gravity acts on the second sheet piece, so that the second sheet piece is allowed to fall while or after the pressure-sensitive adhesives adhering again to each other (for example, the first and second pressure-sensitive adhesives) are once slowly dissociated from each other, and therefore, adhesive lacking or adhesive deposit caused by displacement of pressure-sensitive adhesives adhering to each other can be suppressed, so that the second sheet piece can be successfully removed without an additional carrier film as used in conventional techniques. FIG. 3 is a diagram for illustrating a mechanism for slowly dissociating the second sheet piece from the carrier film. As shown in FIG. 3, the pressure-sensitive adhesive surface of the upper layer is slowly dissociated by the effect of gravity acting on the second sheet piece.

In an embodiment of the invention, in the removal step, the second pressure-sensitive adhesive of the second sheet piece is allowed to face upward, and the second sheet piece is peeled off from the carrier film by feeding the carrier film in an obliquely upward direction and then inwardly bending the carrier film against the second sheet piece.

According to this feature, gravity acts on the second sheet piece, so that the second sheet piece is allowed to fall while or after the pressure-sensitive adhesives adhering again to each other are once slowly dissociated from each other in a preferred manner, and therefore, adhesive lacking or adhesive deposit caused by displacement of pressure-sensitive adhesives adhering to each other can be suppressed more effectively.

In an embodiment of the invention, in the removal step, the second sheet piece is peeled off from the carrier film by the first peeling means.

According to this feature, there is no need to provide the second peeling means separately, so that the system cost can be reduced.

In an embodiment of the invention, in the bonding step, the first sheet piece peeled off in the first peeling step is bonded to the liquid crystal panel from a lower side with the first pressure-sensitive adhesive interposed therebetween.

In an embodiment of the invention, the first sheet piece is peeled off from the carrier film at a first peeling point, the second sheet piece is peeled off from the carrier film at a second peeling point located upstream of the first peeling point, and;

the removal step further includes a peeling means shifting control step including shifting the second peeling means to the second peeling point before the second sheet piece is peeled off from the carrier film.

According to this feature, the second peeling means for peeling off the second sheet piece is placed upstream of the bonding position of the bonding means, so that there is no risk of adhesion of the second sheet piece to the bonding means.

In an embodiment of the invention, the second peeling means comprises part of a plurality of feed rollers for feeding the carrier film. According to this feature, the second sheet piece can be peeled off using a simple device configuration.

In an embodiment of the invention, the removal step further comprises a holding step including holding the fallen second sheet piece. According to this feature, the fallen second sheet pieces can be collected while the second pressure-sensitive adhesive is prevented from adhering to the surrounding devices. In addition, when the second sheet pieces are piled in the holding means, new holding means can be substituted by easy operation without stopping the manufacturing line.

### BRIEF DESCRIPTION OF THE DRAWINGS

FIG. 1 is a schematic diagram showing an example of the system for manufacturing a liquid crystal display device;

FIG. 2 is a schematic diagram showing an example of the removal means;

FIG. 3 is a diagram for illustrating a mechanism for removing the second sheet piece;

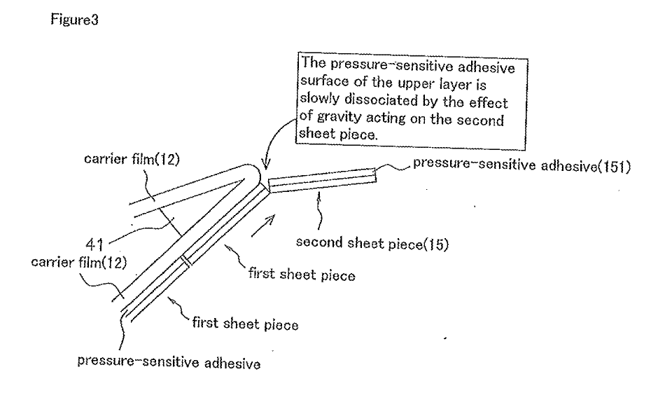

FIGS. 4A to 4D are schematic diagrams showing another example of the removal means; and

FIGS. 5A to 5D are schematic diagrams showing a further example of the removal means.

### EMBODIMENTS FOR CARRYING OUT THE INVENTION

### Embodiment 1

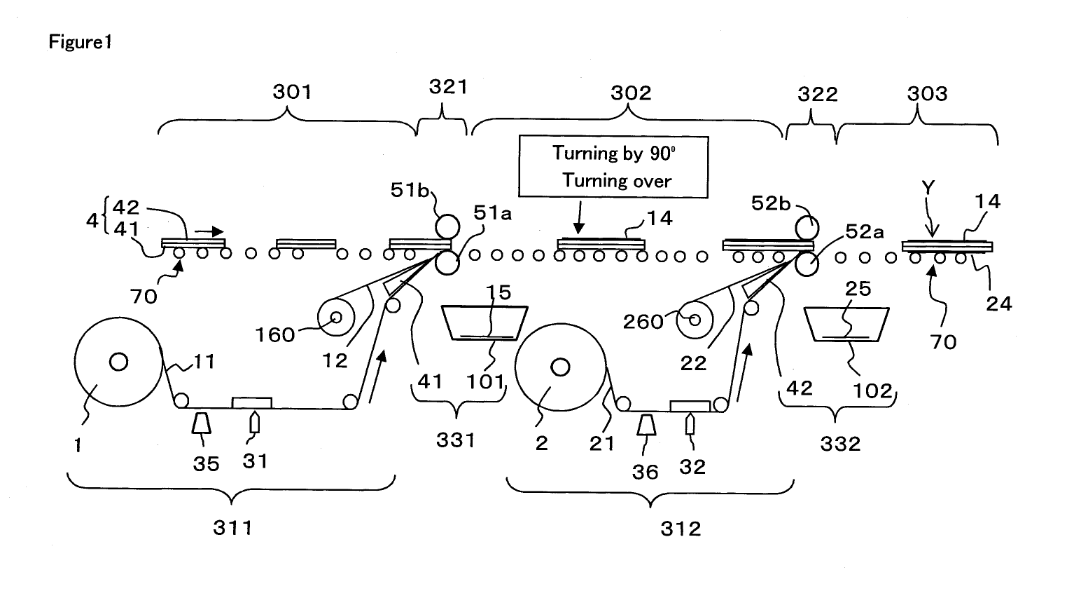

The system and the method according to this embodiment for continuously manufacturing a liquid crystal display device are more specifically described with reference to FIG. 1. It will be understood that the embodiment is not intended to limit the scope of the invention.

For example, a continuous roll of polarizing film may be (1) a roll of an optical film laminate that is in the form of a continuous web and includes a carrier film and a polarizing film formed on the carrier film with a pressure-sensitive adhesive interposed therebetween. In this case, the system for continuously manufacturing a liquid crystal display device further includes cutting means for forming first and second sheet pieces from the polarizing film by cutting (half-cutting or forming score lines in) the polarizing film and the pressure-sensitive adhesive at predetermined intervals in a direction perpendicular to the feed direction of the carrier film, while the carrier film is left uncut. To increase the polarizing film yield, the cutting means preferably forms score lines in such a manner that the feed direction length of the second sheet piece is smaller than the feed direction length of the first sheet piece.

Alternatively, for example, a continuous roll of polarizing film may be (2) a roll of an optical film laminate including a carrier film and first and second sheet pieces of polarizing films, which are formed on the carrier film with first and second pressure-sensitive adhesives interposed therebetween, respectively and placed adjacent to one another in a direction perpendicular to the feed direction of the carrier film with a score line interposed between the adjacent pieces (a so-called scored continuous roll). To increase the polarizing film yield, the score lines are preferably formed in such a manner that the feed direction length of the second sheet piece is smaller than the feed direction length of the first sheet piece.

For example, the continuous rolls 1 and 2 shown in FIG. 1 are each a roll of an optical film laminate 11 including a carrier film 12 and a polarizing film (containing a pressure-sensitive adhesive) that has an absorption axis parallel to the feed direction (longitudinal direction) and is formed on the carrier film 12 with the pressure-sensitive adhesive interposed therebetween. For example, the polarizing film includes a polarizer (about 5 to about 80 μm in thickness) and a polarizer protecting film or films (generally about 1 to about 500 μm in thickness) formed on one or both sides of the polarizer with or without an adhesive. The optical film laminate 11 may further include any other film component such as a retardation film (generally 10 to 200 μm in thickness), a viewing angle compensation film, a brightness enhancement film, or a surface protecting film. The thickness of the optical film laminate is typically in the range of 10 μm to 500 μm. The pressure-sensitive adhesive interposed between the carrier film and the polarizing film is typically, but not limited to, an acryl-based pressure-sensitive adhesive, a silicone pressure-sensitive adhesive, a urethane pressure-sensitive adhesive, or the like. For example, the thickness of the pressure-sensitive adhesive layer is preferably in the range of 10 to 50 μm. For example, the carrier film to be used may be a known conventional film such as a plastic film (e.g., a polyethylene terephthalate film or a polyolefin film). According to conventional techniques, any appropriate film such as a film coated with an appropriate release agent such as a silicone, long-chain alkyl or fluoride release agent, or molybdenum sulfide release agent may also be used as needed.

(Liquid Crystal Display Device)

The liquid crystal display device includes a liquid crystal panel and at least a sheet piece or pieces of polarizing film provided on one or both sides of the liquid crystal panel, into which a driving circuit is incorporated as needed. The liquid crystal panel to be used may be of any type such as a vertical alignment (VA) type or an in-plane switching (IPS) type. The liquid crystal panel 4 has a structure including a pair of substrates (first and second substrates 41 and 42) opposed to each other and a liquid crystal layer sealed in between the substrates.

The system according to this embodiment for continuously manufacturing a liquid crystal display device includes liquid crystal panel supply means 301, optical film laminate supply means 311, bonding means 321 (a bonding roller 51a and a guide roller 51b), removal means 331, liquid crystal panel feeding means 302, optical film laminate supply means 312, bonding means 322 (a bonding roller 52a and a guide roller 52b), removal means 332, and liquid crystal display device feeding means 303. In this embodiment, one first sheet piece 14 is bonded to a liquid crystal panel from the lower side. Subsequently, the liquid crystal panel with the first sheet piece 14 bonded thereto is turned by 90° and turned over, and another first sheet piece 24 is bonded to the liquid crystal panel from the lower side.

The liquid crystal panel supply means 301 supplies the liquid crystal panel 4 to the bonding means 321. In this embodiment, the liquid crystal panel supply means 301 includes only liquid crystal panel feeding means 70, which is however non-limiting.

The feeding means 70 of the liquid crystal panel 4 includes feed rollers, a suction plate, or other components. The feeding means 70 rotates feed rollers or moves a suction plate to feed the liquid crystal panel 4.

The optical film laminate supply means 311 draws the optical film laminate 11 from the continuous roll 1, inspects the polarizing film for defects, cuts the polarizing film, based on the result of the inspection, to form a first sheet piece 14 or a second sheet piece 15, peels off the first sheet piece 14 and the first pressure-sensitive adhesive from the carrier film 12 by inwardly folding back the carrier film 12 against the first sheet piece 14, and supplies the first sheet piece 14 to the bonding means 321. For the operation, the optical film laminate supply means 311 includes defect inspecting means 35, cutting means 31, peeling means 41, and take-up means 160. The optical film laminate supply means 311 also includes film feeding means for feeding the optical film laminate 11 (the carrier film 12), such as feed rollers (not shown) or nip rollers (not shown) and the take-up means 160, and a film feeding control unit (not shown) for driving and controlling the film feeding means, in which the film feeding control unit controls the film feeding depending on the bonding process or the removal process.

The defect inspecting means 35 inspects the polarizing film for defects. Examples of the defects include scratches, air bubbles, and foreign bodies. For example, the defect inspecting means 35 may include imaging means for imaging reflected light or transmitted light and a device for analyzing the image to determine defects. In another embodiment, for example, the defect inspecting means 35 may include means for determining defects based on defect information (including at least information about the positions of defects) provided on the polarizing film or the carrier film 12.

Based on the result of the inspection by the defect inspecting means 35, the cutting means 31 cuts the polarizing film in a direction perpendicular to the feed direction of the carrier film to form a first sheet piece 14 or a second sheet piece 15 on the carrier film 12. For example, the cutting means 31 cuts the polarizing film so as to classify a non-defective sheet piece and a defective sheet piece, which are determined to be non-defective and defective, respectively, in the inspection by the defect inspecting means 35. For example, the cutting means 31 may be a cutter, a laser, or the like.

When the first sheet piece 14 is bonded to the liquid crystal panel 4, the peeling means 41 inwardly folds back the carrier film 12 against the first sheet piece 14 to peel off the first sheet piece 14 from the carrier film 12 (the first peeling step). In this embodiment, a sharp knife edge part is used as a non-limiting example of the front end of the peeling means 41.

The take-up means 160 takes up the carrier film 12 from which the first sheet piece 14 and the second sheet piece 15 have been peeled off.

The bonding means 321 (corresponding to the bonding means) bonds the first sheet piece 14, which is supplied by the optical film laminate supply means 311, to the first substrate 41 of the liquid crystal panel 4, which is supplied by the liquid crystal panel supply means 301, with the first pressure-sensitive adhesive interposed therebetween (the bonding step). In this embodiment, the bonding means 321 includes a bonding roller 51a and a guide roller 51b.

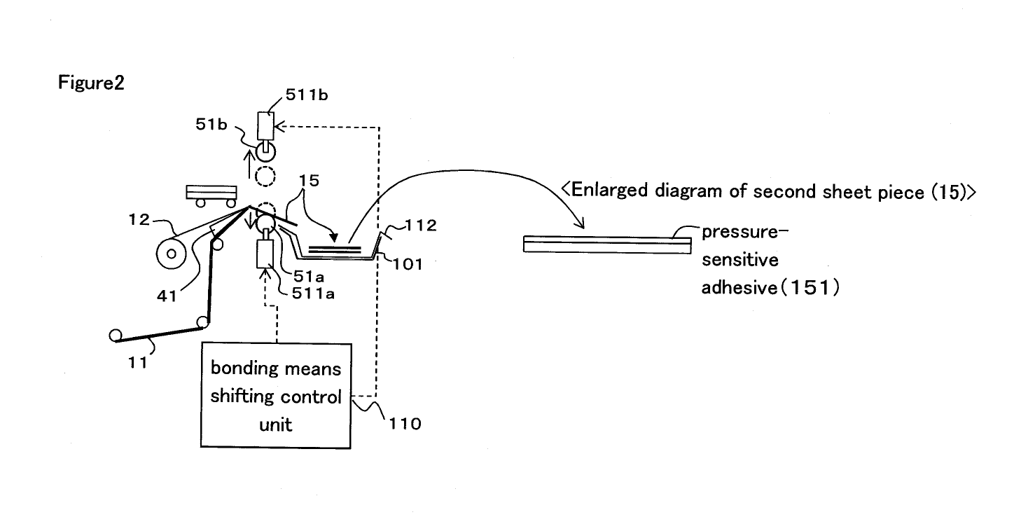

The removal means 331 includes second peeling means 41 (which also corresponds to the first peeling means in this embodiment), a bonding means shifting control unit 110, and a holding container 101. As shown in FIG. 2, the removal means 331 has second peeling means 41 for peeling off the second sheet piece 15 by inwardly folding the carrier film 12 against the second sheet piece 15 with the second pressure-sensitive adhesive 151 facing upward. The second sheet piece 15 peeled off by the second peeling means 41 is allowed to fall when removed (the removing step). When removing the second sheet piece 15, the second peeling means 41 preferably allows the second pressure-sensitive adhesive 151 of the second sheet piece 15 to face upward and preferably peels off the second sheet piece 15 from the carrier film 12 by feeing the carrier film 12 in an obliquely upward direction and then inwardly folding the carrier film 12 against the second sheet piece 15. In this embodiment, the second peeling means 41 has both the function of peeling off the first sheet piece 14 and the function of peeling off the second sheet piece 15. The film feeding control unit (not shown) controls the film feeding according to the removal process.

The bonding means shifting control unit 110 shifts the bonding means 321 in such a manner that the falling of the second sheet piece 15 peeled off from the carrier film 12 by the second peeling means 41 is not interfered with (the bonding means shifting step). This ensures a fall path for the second sheet piece 15. When the second peeling means 41 peels off the second sheet piece 15, for example, the bonding means shifting control unit 110 drives an air cylinder 511a to place the bonding roller 51a below the path through which the separated second sheet piece 15 travels. The bonding means shifting control unit 110 also drives another air cylinder 511b to place the guide roller 51b above the path through which the separated second sheet piece 15 travels. Therefore, the second sheet piece 15 is allowed to fall without interfering with the bonding roller 51a and the guide roller 51b. It will be understood that the bonding roller 51a may or may not rotate when the second sheet piece 15 falls. The bonding means shifting control unit 110 may also function as means for driving the bonding roller 51a and the guide roller 51b in the process of bonding the first sheet piece to the liquid crystal panel 4. Air cylinders have been described as means for shifting the bonding roller 51a and the guide roller 51b, but this is not intended to limit the scope of the invention, and any other known linear motion device such as an oil hydraulic cylinder, an electric cylinder, or a rack and pinion may also be used.

The holding container 101 (corresponding to the holding means) holds the fallen second sheet piece 15 (the holding step). The holding container 101 also has an underlay member 112 removably provided on at least the holding bottom surface. When the underlay member 112 is not provided, the holding container 101 preferably has undergone a release treatment on its holding surface to be in contact with the fallen second sheet piece 15.

The liquid crystal panel feeding means 302 feeds, to the bonding means 322, the liquid crystal panel 4 with the first sheet piece 14 bonded thereto by the bonding means 321. In this embodiment, the liquid crystal panel feeding means 302 includes a turning mechanism (not shown) for horizontally turning by 90° the liquid crystal panel 4 with the first sheet piece 14 bonded thereto and a turn-over mechanism for turning over the liquid crystal panel 4.

The optical film laminate supply means 312 draws an optical film laminate 21 from a continuous roll 2, inspects the polarizing film for defects, cuts the polarizing film, based on the result of the inspection, to form a first sheet piece 24 or a second sheet piece 25, peels off the first sheet piece 24 from the carrier film 22 by inwardly folding back the carrier film 22 against the first sheet piece 24, and supplies the first sheet piece 24 to the bonding means 322. For the operation, the optical film laminate supply means 312 includes defect inspecting means 36, cutting means 32, peeling means 42, and take-up means 260. The optical film laminate supply means 312 may also include the same film feeding means for feeding the optical film laminate 21 (the carrier film 22) as that of the optical film laminate supply means 311.

The defect inspecting means 36 achieves the same function as the defect inspecting means 35, and the cutting means 32 also achieves the same function as the cutting means 31 and therefore forms the first sheet piece 24 containing the first pressure-sensitive adhesive or the second sheet piece 25 containing the second pressure-sensitive adhesive on the carrier film 22. The peeling means 42 achieves the same function as the peeling means 41 and therefore peels off the first sheet piece 24 from the carrier film 22 (the first peeling step). The take-up means 260 achieves the same function as the take-up means 160.

The bonding means 322 bonds the first sheet piece 24 to the second substrate 42 of the liquid crystal panel 4 with the first pressure-sensitive adhesive interposed therebetween to form a liquid crystal display device Y (the bonding step). In this embodiment, the bonding means 322 includes a bonding roller 52a and a guide roller 52a.

The removal means 332 includes second peeling means 42 (which also corresponds to the first peeling means in this embodiment), a bonding means shifting control unit (not shown), and holding means 102. The removal means 332 has second peeling means 42 for peeling off the second sheet piece 25 by inwardly folding the carrier film 22 against the second sheet piece 25 with the second pressure-sensitive adhesive facing upward. The second sheet piece 25 peeled off by the second peeling means 42 is allowed to fall when removed (the removing step). In this embodiment, the second peeling means 42 has both the function of peeling off the first sheet piece 24 and the function of peeling off the second sheet piece 25. The film feeding control unit (not shown) controls the film feeding according to the removal process.

The bonding means shifting control unit (not shown) shifts the bonding means 322 in such a manner that the falling of the second sheet piece 25 peeled off from the carrier film 22 by the second peeling means 42 is not interfered with. The bonding means shifting control unit may have the same configuration as the bonding means shifting control unit 110.

A holding container 102 (corresponding to the holding means) holds the fallen second sheet piece 25. The holding container 102 may also have an underlay member (not shown) removably provided on the holding bottom surface, or the holding container 102 may have undergone a release treatment on its holding surface.

The liquid crystal display device feeding means 303 feeds the liquid crystal display device Y formed by the bonding means 322. An inspection apparatus for inspecting the liquid crystal display device Y may also be provided at a downstream feed site. The purpose and method of the inspection are not restricted.

(Other Polarizing Film Rolls)

In this embodiment, the polarizing films of the continuous rolls 1 and 2 both have an absorption axis parallel to the feed direction (longitudinal direction), but the direction of the absorption axis of each of the polarizing films is not limited thereto. Alternatively, for example, the polarizing film of the continuous roll 1 may have an absorption axis parallel to the transverse direction (width direction), and the polarizing film of the continuous roll 2 may have an absorption axis parallel to the longitudinal direction. In this case, the turning mechanism for horizontally turning by 90° the liquid crystal panel may be omitted as needed.

### Removal Means According to Another Embodiment 1

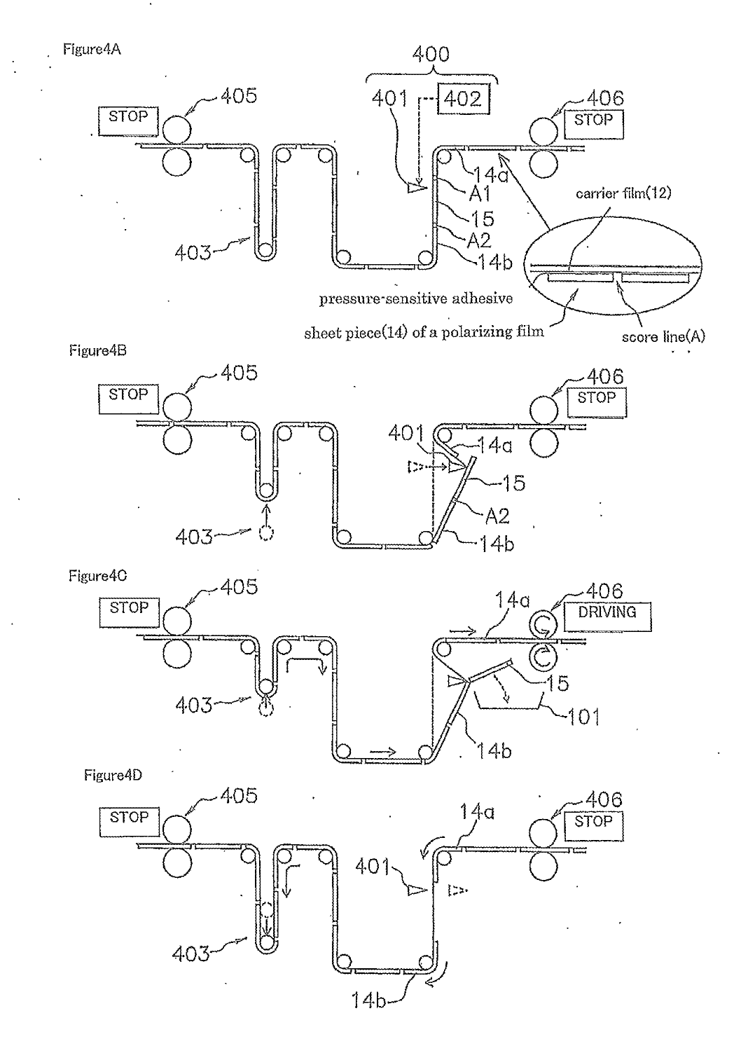

As shown in FIGS. 4A to 4D, removal means 400 according to another embodiment 1 includes second peeling means 401, a second peeling means shifting control unit 402, and a holding container 101. The second peeling means 401 is located upstream of a first peeling point where the first sheet piece 14 is peeled off from the carrier film 12, and provided movable to a second peeling point 405 where the second sheet piece 15 is peeled off from the carrier film 12. As shown in FIG. 4A, the first sheet piece 14 and the second sheet piece 15 are formed on the carrier film 12, and a score line A represents a half-cut part (cut position) formed in a direction perpendicular to the feed direction of the carrier film 12 (the same applies to other embodiments described below). The second peeling means 401 is located on the carrier film 12 side and on a line perpendicular to the film travel direction. Hereinafter, the operation of peeling off the second sheet piece 15 is described.

In FIG. 4A, the second sheet piece 15 being fed is placed between and adjacent to the first sheet pieces 14a and 14b. The film feeding is stopped when the score line Al between the first sheet piece 14a and the second sheet piece 15 arrives upstream of the contact part where the front edge part of the second peeling means 401 comes into contact with the carrier film 12 (or reaches the contact part) (FIG. 4A). The film feeding is stopped by stopping the driving of feed rollers 405 located upstream of a dancer roller 403 (weight type) and the driving of feed rollers 406 located downstream of the second peeling means 401. Subsequently, the second peeling means shifting control unit 402 drives an air cylinder (not shown) to advance the second peeling means 401 against the carrier film 12 perpendicularly to the film feed direction (the peeling means shifting control step). In this process, the second sheet piece 15 is allowed to protrude from the carrier film 12 as shown in FIG. 4B while the driving of the feed rollers 405 and 406 is stopped. Subsequently, the carrier film 12 is fed by driving the feed rollers 406 while the driving of the feed rollers 405 is stopped, and as shown in FIG. 4C, the carrier film 12 is fed in an obliquely upward direction and then inwardly bent against the second sheet piece 15 with the second pressure-sensitive adhesive facing upward, so that the second sheet piece 15 is peeled off from the carrier film 12, allowed to fall into the holding container 101, and held in the holding container 101 (the holding step). In this process, after the front end of the next first sheet piece 14b (or the score line A2) reaches the front edge part of the second peeling means 401, the film feeding is stopped by stopping the driving of the feed rollers 406. As a matter of course, the former first sheet piece 14a is spaced by the length of the second sheet piece 15. Subsequently, while the driving of the feed rollers 405 and 406 is stopped, the second peeling means shifting control means 402 drives the air cylinder (not shown) to withdraw the second peeling means 401 to the original position, and moves the carrier film 12 to the upstream side (the dancer roller 403). The first sheet piece 14b is fed as it is to the bonding means 321, and the next second sheet piece is subjected to the removal process when arriving. The control of the operation of the film feeding means (such as the feed rollers 405 and 406) and the control of the operation of the dancer roller 403 are achieved by the function of the film feeding control unit of the optical film laminate supply means 311. In the above example, because of the presence of the dancer roller 403 (weight type), the series of feed path changing processes have no process of exposing the pressure-sensitive adhesive surface of the first sheet piece, so that there is no risk of trapping foreign bodies or no deformation of the pressure-sensitive adhesive caused by the entrainment of air bubbles or the like due to re-adhesion.

The shift of the second peeling means 401 may be forward and backward shift as described above or shift through any other path or may include rotational shift. While the front end of the second peeling means 401 shown in FIGS. 4A to 4D is in the shape of a knife edge, it may be in any other shape such as a roller shape. The line for feeding the carrier film 12 does not have to be U-shaped as shown in FIGS. 4A to 4D. The second peeling means 401 is preferably placed by the carrier film 12 being fed in an upward direction. An air cylinder has been described as means for shifting the second peeling means 401, but this is non-limiting, and any other known linear motion device such as an oil hydraulic cylinder, an electric cylinder, or a rack and pinion may also be used.

### Removal Means According to Another Embodiment 2

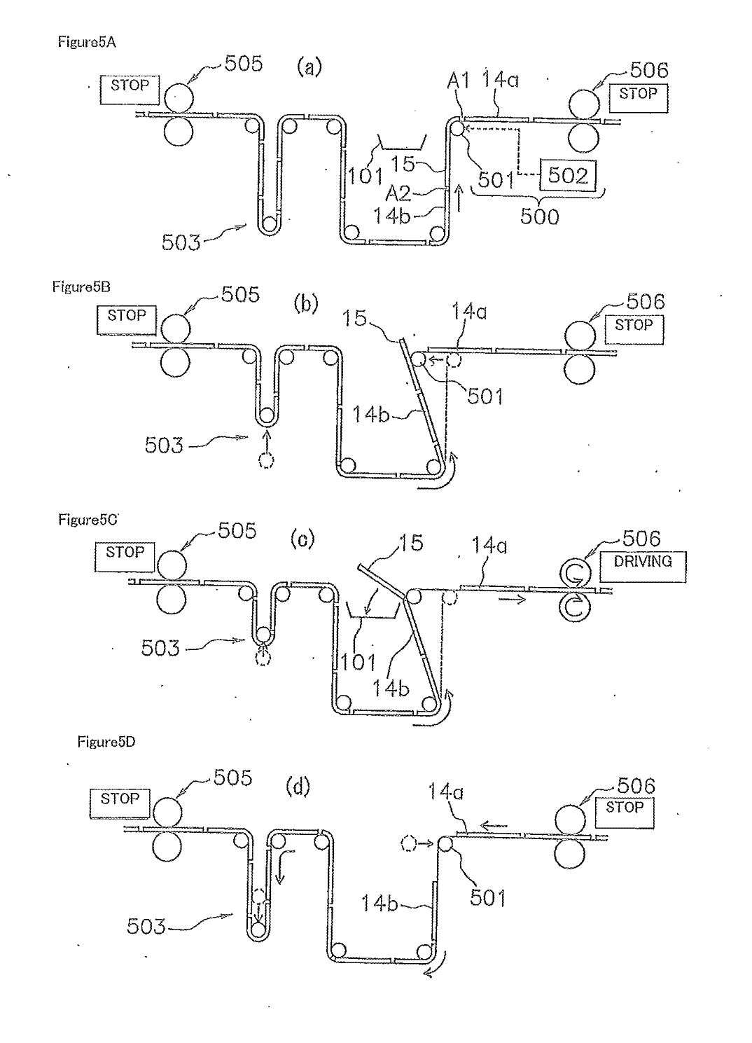

Removal means 500 according to another embodiment 2 includes second peeling means (a feed roller 501), a peeling means shifting control unit (a feed roller shifting control unit 502), and a holding container 101. The second peeling means shown in FIG. 5A is located upstream of a first peeling point where the first sheet piece 14 is peeled off from the carrier film 12, and provided movable to a second peeling point where the second sheet piece 15 is peeled off from the carrier film 12. As shown in FIG. 5A, the second peeling means according to this embodiment includes part of a plurality of feed rollers 501 for feeding the carrier film 12. In FIG. 5A, the feed roller 501 of the second peeling means is placed to change the feed direction of the carrier film 12 by 90 degrees by coming into contact with the carrier film 12 located inside. Hereinafter, the operation of peeling off the second sheet piece 15 is described.

In FIG. 5A, the second sheet piece 15 being fed is placed between and adjacent to the first sheet pieces 14a and 14b. The film feeding is stopped when the score line A1 between the first sheet piece 14a and the second sheet piece 15 arrives upstream of the contact part where the feed roller 501 comes into contact with the carrier film 12 (or reaches the contact part) (FIG. 5A). The film feeding is stopped by stopping the driving of feed rollers 505 located upstream of a dancer roller 503 (weight type) and the driving of feed rollers 506 located downstream of the feed roller 501. Subsequently, the feed roller shifting control unit 502 drives an air cylinder (not shown) to advance the feed roller 501 against the carrier film 12 so that the angle of the film feed direction is changed from 90 degrees to an acute angle (the peeling means shifting control step). In this process, the second sheet piece 15 is allowed to protrude from the carrier film 12 as shown in FIG. 5B while the driving of the feed rollers 505 and 506 is stopped. Subsequently, the carrier film 12 is fed by driving the feed rollers 506 while the driving of the feed rollers 505 is stopped, and as shown in FIG. 5C, the carrier film 12 is fed in an obliquely upward direction and then inwardly bent against the second sheet piece 15 with the second pressure-sensitive adhesive facing upward, so that the second sheet piece 15 is peeled off from the carrier film 12, allowed to fall into the holding container 101, and held in the holding container 101 (the holding step). In this process, after the front end of the next first sheet piece 14b (or the score line A2) reaches the contact part with the feed roller 501, the film feeding is stopped by stopping the driving of the feed rollers 506. As a matter of course, the former first sheet piece 14a is spaced by the length of the second sheet piece 15.

Subsequently, while the driving of the feed rollers 505 and 506 is stopped, the feed roller shifting control unit 502 drives the air cylinder (not shown) to withdraw the feed roller 501 to the original position, and moves the carrier film 12 to the upstream side (the dancer roller 503). The first sheet piece 14b is fed as it is to the bonding means 321, and the next second sheet piece is subjected to the removal process when arriving. The control of the operation of the film feeding means (such as the feed rollers 505 and 506) and the control of the operation of the dancer roller 503 are achieved by the function of the film feeding control unit of the optical film laminate supply means 311. In the above example, because of the presence of the dancer roller 503 (weight type), the series of feed path changing processes have no process of exposing the pressure-sensitive adhesive surface of the first sheet piece, so that there is no risk of trapping foreign bodies or no deformation of the pressure-sensitive adhesive caused by the entrainment of air bubbles or the like due to re-adhesion.

An air cylinder has been described as means for shifting the feed roller 501, but this is non-limiting, and any other known linear motion device such as an oil hydraulic cylinder, an electric cylinder, or a rack and pinion may also be used. In the above embodiment, the feed roller 501 of the second peeling means shown in FIG. 5A is placed to change the feed direction of the carrier film 12 by 90 degrees by coming into contact with the carrier film 12 located inside. This placement is not intended to limit the scope of the invention, and for example, the feed roller of the second peeling means may be placed to change the feed direction of the carrier film 12 by a predetermined angle (exclusive of 90 degrees) or placed along the feed direction of the carrier film 12 (along a linear line).

The removal means according to other embodiments 1 and 2 both perform the peeling process (step) at a position upstream of where the bonding process (step) is performed, and remove the second sheet piece by a peeling process (step) that includes the step of inwardly folding (bending) the carrier film against the second sheet piece. In particular, embodiment 2 includes the step of inwardly bending the carrier film using the feed roller 501 for feeing the carrier film.

### Other Embodiments

In embodiments 1 and 2 described above, one first sheet piece is bonded to the liquid crystal panel from the lower side, and then after the liquid crystal panel is turned over (upside down), another first sheet piece is bonded to the liquid crystal panel from the lower side. However, this is non-limiting. Alternatively, for example, one first sheet piece may be bonded to the liquid crystal panel from the upper side, and then after the liquid crystal panel is turned over, another first sheet piece may be bonded to the liquid crystal panel from the upper side. Alternatively, after one first sheet piece is bonded to the liquid crystal panel from the lower side, another first sheet piece may be bonded to the liquid crystal panel from the upper side without turning over the liquid crystal panel, or after one first sheet piece is bonded to the liquid crystal panel from the upper side, another first sheet piece may be bonded to the liquid crystal panel from the lower side without turning over the liquid crystal panel.

1. A method for continuously manufacturing a liquid crystal display device, comprising:
a first peeling step that comprises providing a carrier film on which first and second sheet pieces of polarizing films containing first and second pressure-sensitive adhesives, respectively, are formed, and peeling off the first sheet piece from the carrier film by first peeling means, wherein the first and second sheet pieces are adjacent to each other with a score line interposed therebetween and formed on the carrier film with the first and second pressure-sensitive adhesives interposed therebetween, respectively, and the score line is perpendicular to a feed direction;
a bonding step that comprises bonding the first sheet piece, which is peeled off in the first peeling step, to a liquid crystal panel with the first pressure-sensitive adhesive interposed therebetween to form a liquid crystal display device; and
a removal step that comprises removing the second sheet piece from the carrier film, wherein
the removal step comprises a falling step comprising: peeling off the second sheet piece from the carrier film using second peeling means by inwardly bending the carrier film against the second sheet piece with the second pressure-sensitive adhesive facing upward; and allowing the second sheet piece to fall.

2. The method according to claim 1, wherein in the removal step, the second pressure-sensitive adhesive of the second sheet piece is allowed to face upward, and the second sheet piece is peeled off from the carrier film by feeding the carrier film in an obliquely upward direction and then inwardly bending the carrier film against the second sheet piece.

3. The method according to claim 1, wherein the first peeling means for peeling off the first sheet piece from the carrier film may also serve as the second peeling means;
wherein in the removal step, the second sheet piece is peeled off from the carrier film by the first peeling means.

4. The method according to claim 1, wherein in the bonding step, the first sheet piece peeled off in the first peeling step is bonded to the liquid crystal panel from a lower side with the first pressure-sensitive adhesive interposed therebetween.

5. The method according to claim 1, wherein the first sheet piece is peeled off from the carrier film at a first peeling point, the second sheet piece is peeled off from the carrier film at a second peeling point located upstream of the first peeling point, and;
the removal step further comprises a peeling means shifting control step comprising shifting the second peeling means to the second peeling point before the second sheet piece is peeled off from the carrier film.

6. The method according to claim 5, wherein the second peeling means comprises part of a plurality of feed rollers for feeding the carrier film.

7. The method according to claim 1, wherein the removal step further comprises a holding step comprising holding the fallen second sheet piece.
